(19) United States
(12) Patent Application Publication
(10) Pub. No.: US 2019/0276149 A1
(43) Pub. Date: Sep. 12, 2019

(54) APPARATUS AND METHOD AFFIXING AIRCRAFT DISPLAY MATERIAL THEREOF

(71) Applicant: GROMEX MEDIA GRAPHIC SDN. BHD., Alor Setar (MY)

(72) Inventors: Kee Chong KUA, Puchong (MY); Gim Hong LIM, Alor Setar (MY)

(21) Appl. No.: 16/126,673

(22) Filed: Sep. 10, 2018

(30) Foreign Application Priority Data
Mar. 8, 2018 (MY) PI 2018700908

(51) Int. Cl. B64D 11/00; G09F 21/08; G09F 7/18

(52) U.S. Cl. CPC B64D 11/003; G09F 21/08; G09F 2007/1865; G09F 2007/1847; G09F 7/18

(57) ABSTRACT

The present invention relates to an apparatus (100) and method (200) of affixing display material, more particularly, display material on aircraft interior surface such as overhead stowage bin, comprising the steps of: overlaying the display material on the bin surface (S201), then applying at least one holder on at least one bin edge securing the display material and the bin therein (S202).

### 1. TECHNICAL FIELD OF THE INVENTION

The present invention relates to an apparatus and method of affixing display material, more particularly, display material on aircraft interior surface such as overhead stowage bin, comprising the steps of: overlaying the display material on the bin surface and applying at least one holder on at least one bin edge securing the display material and the bin therein.

### 2. BACKGROUND OF THE INVENTION

Passenger aircraft interior surfaces such as overhead stowage bin, galley, wall panel, food and beverages serving trolleys, and meal tray seat are among common places to be affixed or attached with display materials such as advertising or graphical representations comprising artworks, texts, or the like. In this disclosure, overhead stowage bin is dominantly selected to describe the present invention herein; the invention may be configured to any other type of aircraft interior surfaces.

Overhead stowage bin is a compartment space for passenger luggage and item storage. The bin comprising a lid or door which can be opened upward or downward to access the storage space therein. The bin lid or door external surface is a commonly known a strategic location to affix or attach advertising messages, arts, graphical representations or the like, to achieve ambient or commercial effects for the passengers. The bin lid is generally very light, made of but not limited to, honeycomb core and thermoset resins. The core is wrapped or protected by a thin layer of coating, such as but not limited to, paint or polyvinyl fluoride (PVF). It is known practice that commercial airlines affixing or attaching display materials with adhesive substance directly onto the bin surface containing paint or PVF. However, this poses a problem when the displays needed to be removed or replaced frequently, as removal of the display also causing the thin layer of bin surface to be damaged, exposing the honeycomb therein. Moreover, display material which uses strong adhesive tend to cause severe damage on the honeycomb structure; thus bringing detrimental effect on the bin structural integrity.

In US 2005/0050781A1 by Duim et al., discloses an apparatus and method of affixing and detaching stowage bin which has the display material such as advertising, mural, graphical representations permanently integrated on the bin surface by a lamination means. Thus, the bin lid is dismantled from the bin mounting and reassembled with a new bin lid/door with new display material. In US 2005/0052516A1 by Wilde et al., also discloses another lamination technique of display material (and UV curable printing ink, a partial ingredient therein) on the bin lid surface, forming an integrated bin door of a permanent representation.

Hence it would be advantageous to provide a method to alleviate the shortcoming of the conventional ways of affixing and detaching display material from aircraft interior surfaces without damaging the bin door/lid. Moreover, providing a method of replacing or changing of display material without replacing and damaging the entire bin door.

### 3. SUMMARY OF THE INVENTION

Accordingly, it is the primary aim of the present invention to provide a method of affixing display material on an aircraft interior surface such as overheard stowage bin with ease.

It is yet another objective of the present invention to provide a method of affixing the display material without damaging the bin surface during removal.

It is an object of the present invention to provide a method to enable repeatable affixing the display material without damaging the bin surface.

It is an object of the present invention to provide a method to affixing and detaching display material from the bin surface without requiring disassemble the bin from the bin mounting.

Additional objects of the invention will become apparent with an understanding of the following detailed description of the invention or upon employment of the invention in actual practice.

According to the preferred embodiment of the present invention the following is provided:

A display material holder, comprising:

a spine comprising a first longitudinal edge and second longitudinal edge;

the first longitudinal edge wherein a first surface extended therefrom; and

the second longitudinal edge wherein a second surface extended therefrom;

characterized in that the spine inner surface is configured to encapsulate a bin edge;

the first surface and second surface inner surface is configured to encapsulate the bin outer surface and a display material; and

the spine inner surface, first surface or second surface inner surface comprising an adhesion surface.

An aspect of the invention is provided,

A method of affixing display material on aircraft overhead stowage bin, comprising:

overlaying the display material on the bin surface;

characterized in that

applying at least one holder on at least one bin edge securing the display material and the bin therein.

### 4. BRIEF DESCRIPTION OF THE DRAWINGS

Other aspect of the present invention and their advantages will be discerned after studying the Detailed Description in conjunction with the accompanying drawings in which:

FIG. 1A illustrates overhead storage bins of a design shape and configuration.

FIG. 1B illustrates overhead storage bins of a design shape and configuration.

FIG. 1C illustrates overhead storage bins of a design shape and configuration.

FIG. 1D illustrates overhead storage bins of a design shape and configuration.

FIG. 1E illustrates overhead storage bins of a design shape and configuration.

FIG. 1F illustrates overhead storage bins of a design shape and configuration.

FIG. 1G illustrates overhead storage bins of a design shape and configuration.

FIG. 2 illustrates a conventional method of affixing adhesive directly on the bin surface, then affixing display material thereon.

FIG. 3-A illustrates an exemplary cross sectional view of FIG. 2 at plane I-I showing a curved bin with identical adhesive application area.

FIG. 3-B illustrates an enlarged view of FIG. 3-A in a dashed circle.

FIG. 3-C illustrates yet another embodiment of an exemplary cross sectional view, showing the adhesive material is applied on the inner surface of the bin, and excess display material is folded over the bin top and bottom edges.

FIG. 3-D shows an enlarged view of FIG. 3-C in a dashed circle.

FIG. 4-A shows a plurality of embodiments of the holder.

FIG. 4-B shows a perspective view of an embodiment of the holder, defining its scope.

FIG. 4-C shows a side view of the holder, describing the tacky or adhesion surface thereon.

FIG. 4-D shows a perspective view of the holder, describing the tacky or adhesion surface thereon.

FIGS. 4-E to 4-G show a side view the sequence of the overhead stowage bin surface is affixed with a layer of display material, then the holder is inserted to secure the display material onto the overhead stowage bin.

FIG. 4-H shows a side view of the least preferable holder with tacky surface covering entire inner surface thereon.

FIG. 4-I shows the side view of the least preferably holder with tacky surface causing the display material to crumbled.

FIG. 4-J shows the side view of another embodiment of the holder wherein the surfaces provide compression or clamping force, also capable of returning to original position after being tensioned or stretch opened.

FIGS. 5-A to 5-D show a curved holder top view, perspective view, side view, and front view, respectively.

FIGS. 6-A to 6-D show a squared holder top view, perspective view, side view, and front view, respectively.

FIGS. 7-A to 7-D show a partially curved holder top view, perspective view, side view, and front view, respectively.

FIGS. 8-A to 8-D show a partially squared holder top view, perspective view, side view, and front view, respectively.

FIG. 9-A illustrates the preferred method of the present invention of affixing display material on the bin surface and securing with the holder on the bin edges.

FIG. 9-B shows an enlarged view of FIG. 5-A in a dashed circle.

FIG. 10-A illustrates the present invention method of affixing display material on top of the holder comprising a layer of adhesive, the holder is placed preferably on the bin edges.

FIG. 10-B shows an enlarged view of FIG. 6-A in a dashed circle.

FIG. 11 shows another embodiment of the holder wherein the first surface joins with an opposite holder.

FIGS. 12-A to 12-D show a variety of the holder affixing locations on the bin edges and side edges.

FIG. 13 shows an exemplary process flow of the present invention.

### 5. DETAILED DESCRIPTION OF THE DRAWINGS

In the following detailed description, numerous specific details are set forth in order to provide a thorough understanding of the invention. However, it will be understood by the person having ordinary skill in the art that the invention may be practised without these specific details. In other instances, well known methods, procedures and/or components have not been described in detail so as not to obscure the invention.

The invention will be more clearly understood from the following description of the embodiments thereof, given by way of example only with reference to the accompanying drawings, which are not drawn to scale.

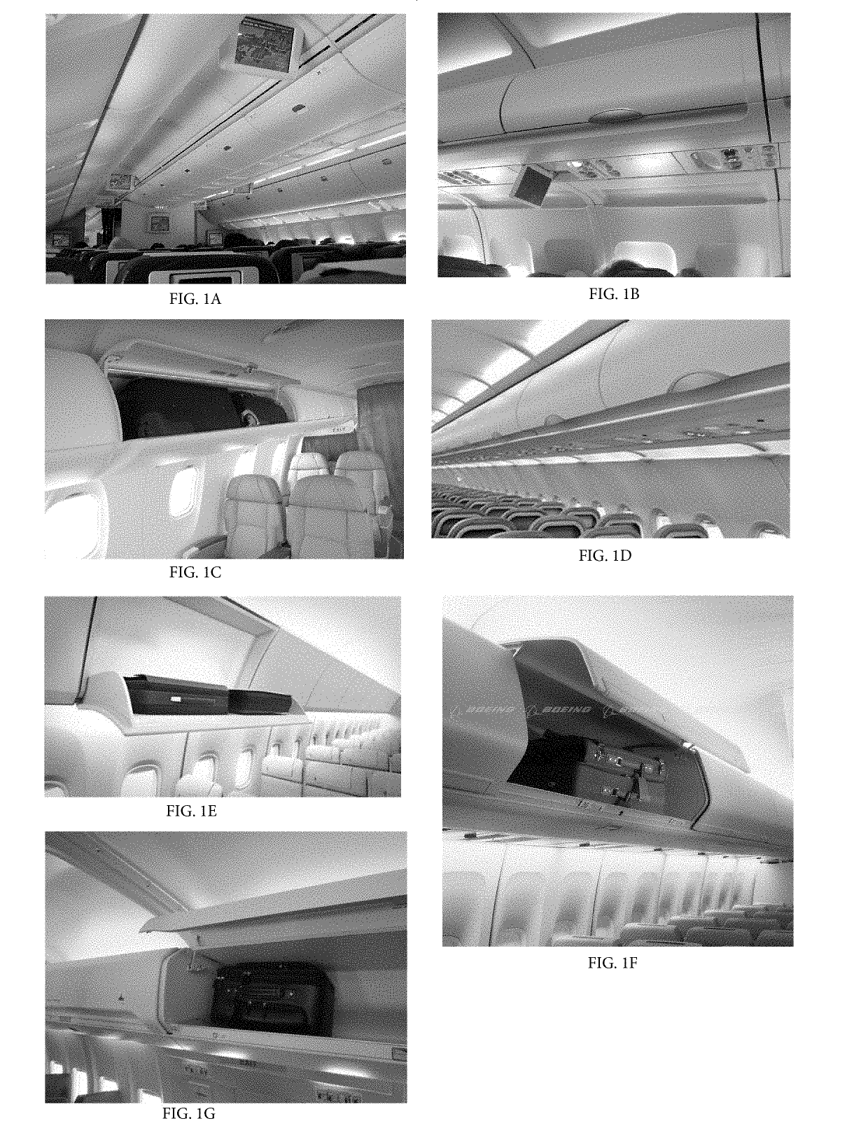

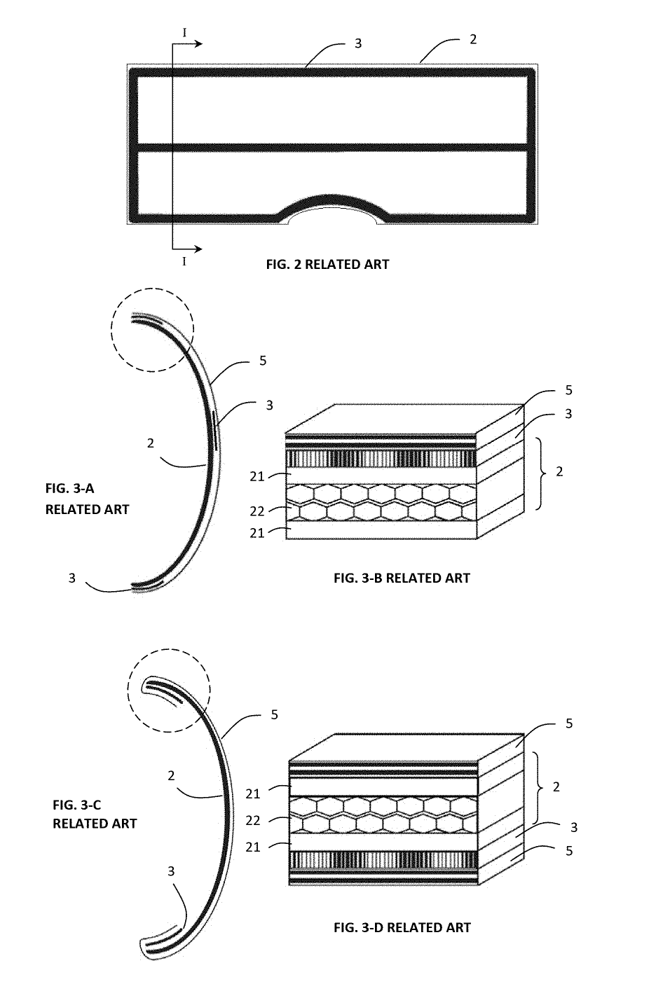

Referring to FIG. 1, there is shown a group of illustrations of different design shape and configuration of overhead stowage bins. The bin door or lid has an external or a first surface which has a combination of curved or flat surfaces which is configured or adapted to different aircraft interior design. Depending on the door configuration, the door can be opened upward or downward. Referring to FIG. 2, this is shown a conventional method of affixing adhesive directly on the bin (2) with adhesive material (3), then affixing display material thereon.

Referring now to FIGS. 3-A and 3-B, there are shown an exemplary cross sectional view of FIG. 2 at plane I-I showing a curved bin with identical adhesive application area, and an enlarged view of FIG. 3-A in a dashed circle, respectively. The bin (2) comprising lightweight, honeycomb core (22) which can be made of fiberous material, the core (22) which either wrapped, laminated, or protected by a thin layer of coating (21) which can be a type of polymer, not limiting to low flammability material such as polyvinyl fluoride (PVF). The conventional method of applying a layer of adhesive (3) then affixing a display material (5) thereon. The display material (5) can be such as advertising or graphical representations, artworks, texts, or the like. The display material (5) can be made of, but not limiting to, polyethylene terephthalate (PET), low density polyethylene (LDPE), high density polyethylene (HDPE), polyester (PE), vinyl, polycarbonate (PC), polystyrene (PS), polyvinylchloride (PVC), polypropylene (PP), or other thermoplastic variants

Referring to FIG. 3-C, there is shown another conventional method of the adhesive material (3) is applied on the inner surface of the bin (2), and excess display material (5) is folded over the bin top and bottom edges and then the display material (5) is firmly pressed to secure in that location, FIG. 3-D shows an enlarged view of FIG. 3-C in a dashed circle.

The aforementioned conventional methods cause damage on the layer of coating (21) or the honeycomb core (22), thus making the bin surface not aesthetically appealing.

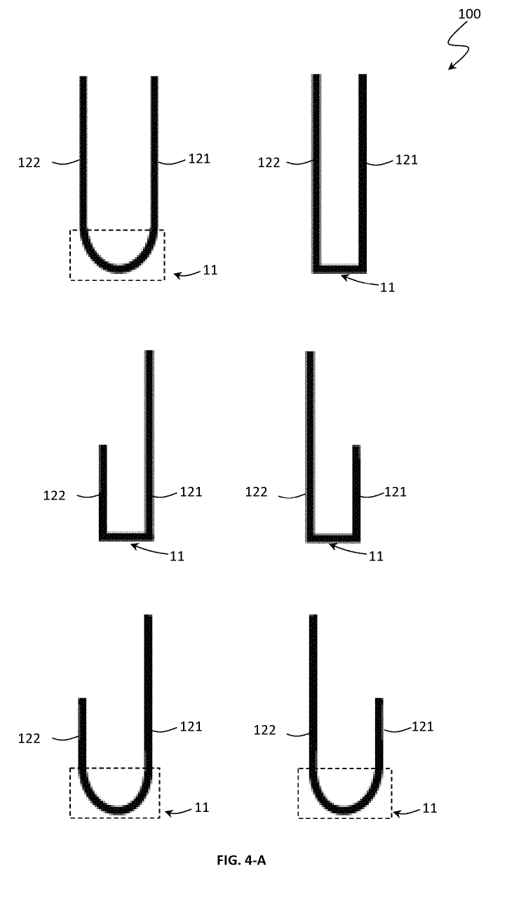

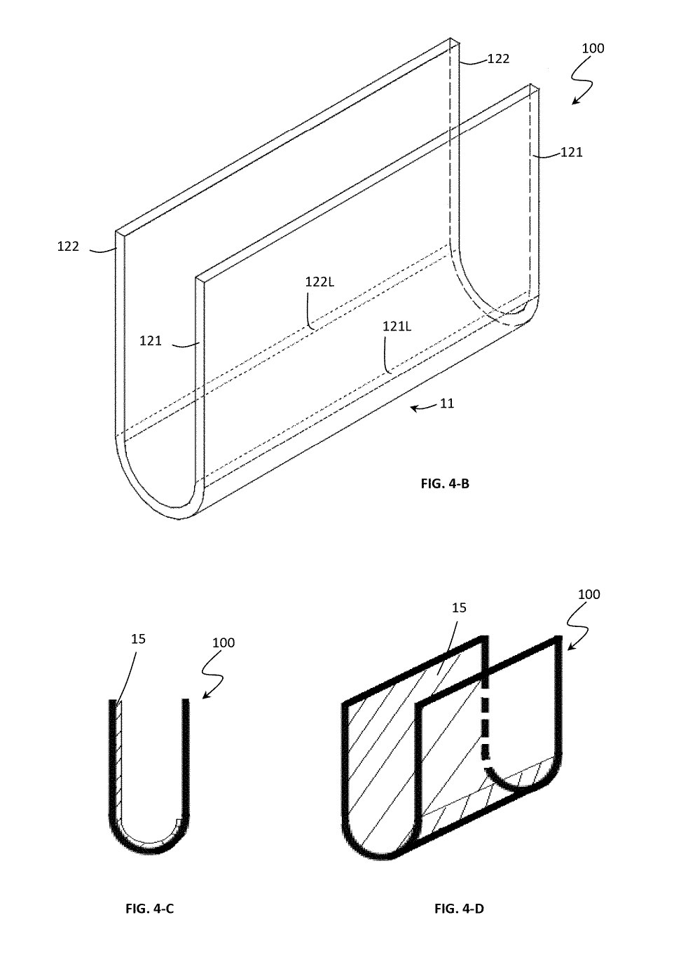

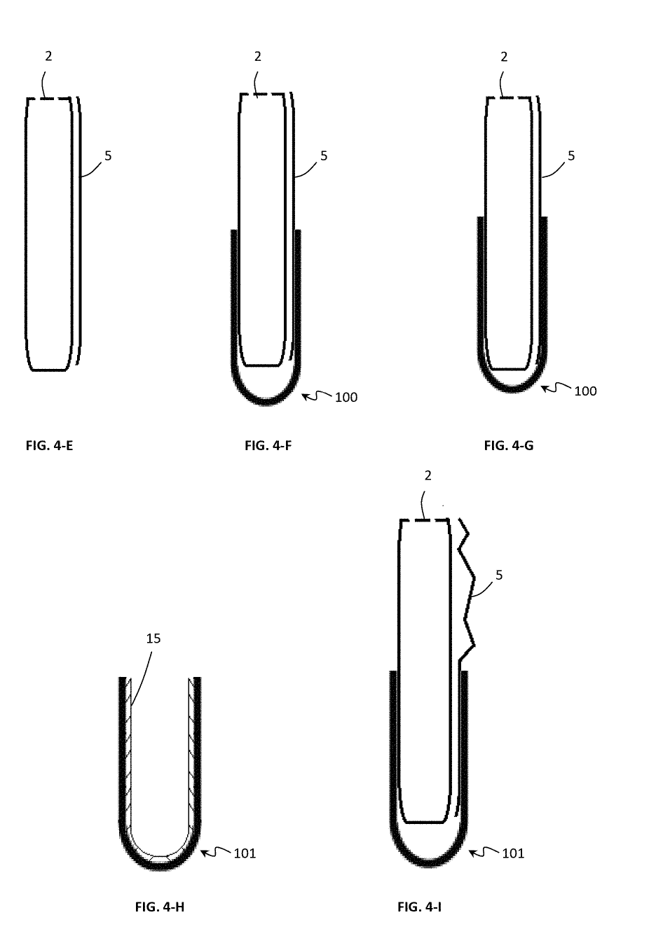

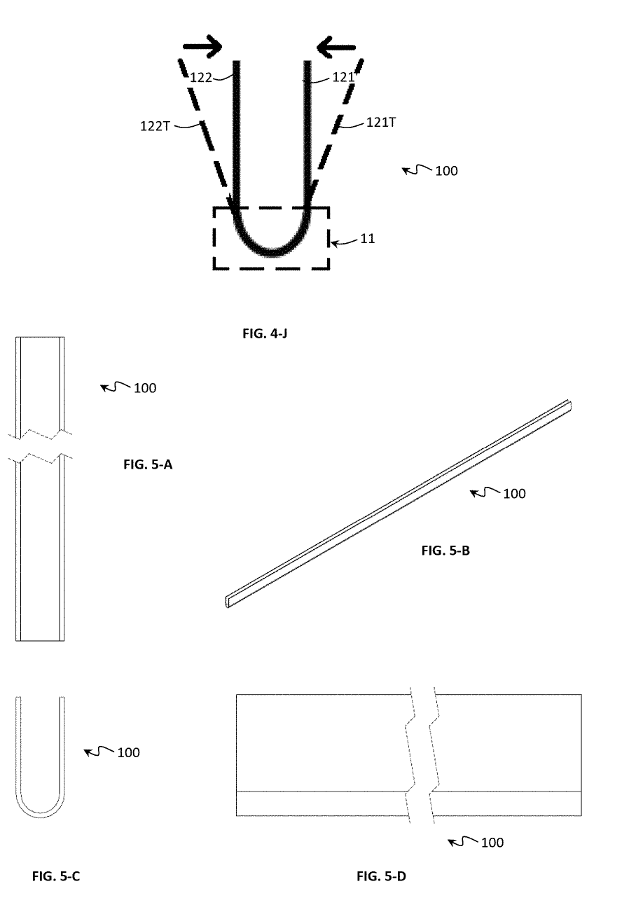

Referring to FIGS. 4-A, there is shown a plurality of embodiments of the holder and a perspective view of an embodiment of the holder, defining its scope, respectively. A display material holder (100), comprising: a spine (11) comprising a first longitudinal edge and second longitudinal edge; the first longitudinal edge wherein a first surface (121) extended therefrom; and the second longitudinal edge wherein a second surface (122) extended therefrom.

It is preferably that the spine inner surface can be configured to encapsulate along a bin (2) edge. The first surface and second surface inner surface is configured to encapsulate the bin outer surface and a display material (5).

Referring to FIG. 4-B, there is shown a perspective view of the holder (100) comprising: a spine (11) comprising a first longitudinal edge (121L) and second longitudinal edge (122L), the first longitudinal edge wherein a first surface (121) extended therefrom; and the second longitudinal edge wherein a second surface (122) extended therefrom.

Referring to FIGS. 4-C and 4-D, there are shown a side view of the holder, describing the tacky or adhesion surface thereon; and a perspective view of the holder, describing the tacky or adhesion surface thereon, respectively. The spine, first surface or second surface inner surface comprising an adhesion surface (15). In addition, the adhesion surface (15) has a homogeneous or non-homogeneous material as the holder (100).

To achieve the tacky or adhesion effect, the adhesion surface (15) comprising dents, ribs, hooks, lumps, apertures, indentations, or combination thereof.

Also to achieve desirable aesthetic appearance, the display material holder (100) is made of transparent, opaque, or translucent material.

The display material holder (100) is made of, but not limiting to, rigid or flexible polyvinyl (PVC); low density or high density polyethylene (LDPE/HDPE); polypropylene, homo or copolymer polypropylene; styrene copolymers such as acrylonitrile-butadiene styrene (ABS), acrylate styrene acrylonitrile (ASA), styrene acrylonitrile (AS); ethylene vinyl acetate (EVA); methyl methacrylate acrylonitrile butadiene styrene (MARS); thermoplastic or its variants, metal, fiberglass, kevlar, composite materials, or a combination thereof.

Furthermore, the display material holder (100) can be made of TPV rubber, nitrile PVC rubber blend, EPDM rubber blend, foam rubber, silicone rubber, or any rubber variants. It is preferable that the holder (100) contains fire retardant material or such characteristics required to comply with interior aircraft part airworthiness safety regulations. The display material (5) may comprise adhesive material, detachable fastener, hook and loop fastener, such as but not limiting to velcro. The display material (5) is made of polyethylene terephthalate, low density polyethylene, high density polyethylene, polyester, vinyl, polycarbonate, polystyrene, polyvinylchloride, polypropylene, or a combination thereof, or other thermoplastic variants thereof.

Referring to FIGS. 4-E to 4-G, there are shown a side view the sequence of the overhead stowage bin surface is affixed with a layer of display material, then the holder is inserted to secure the display material onto the overhead stowage bin (2).

It is our finding that tackiness or adhesion which covers all inner surface of holder may not deliver a desirable effect in the installation. Referring to FIG. 4-H there is shown a side view of the least preferable holder with tacky surface covering entire inner surface thereon and FIG. 4-I shows the side view of the least preferable holder (101) with tacky surface (15) causing the display material (5) to crumbled due to the upward pushing force.

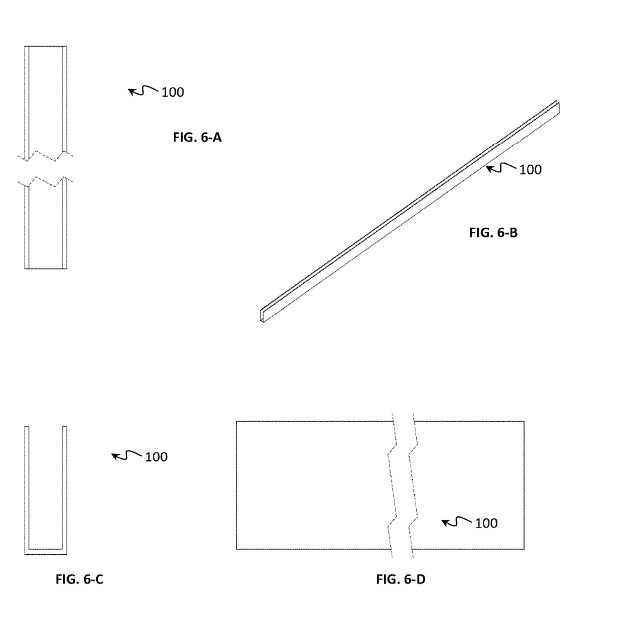

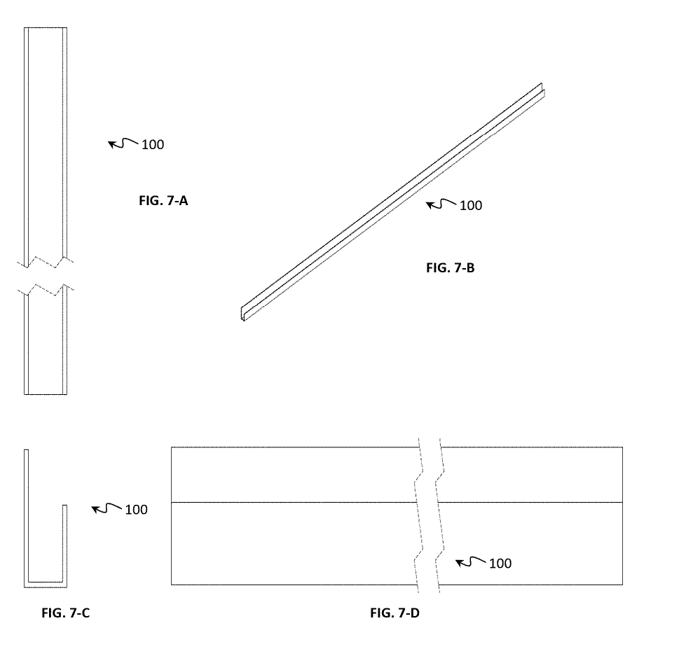

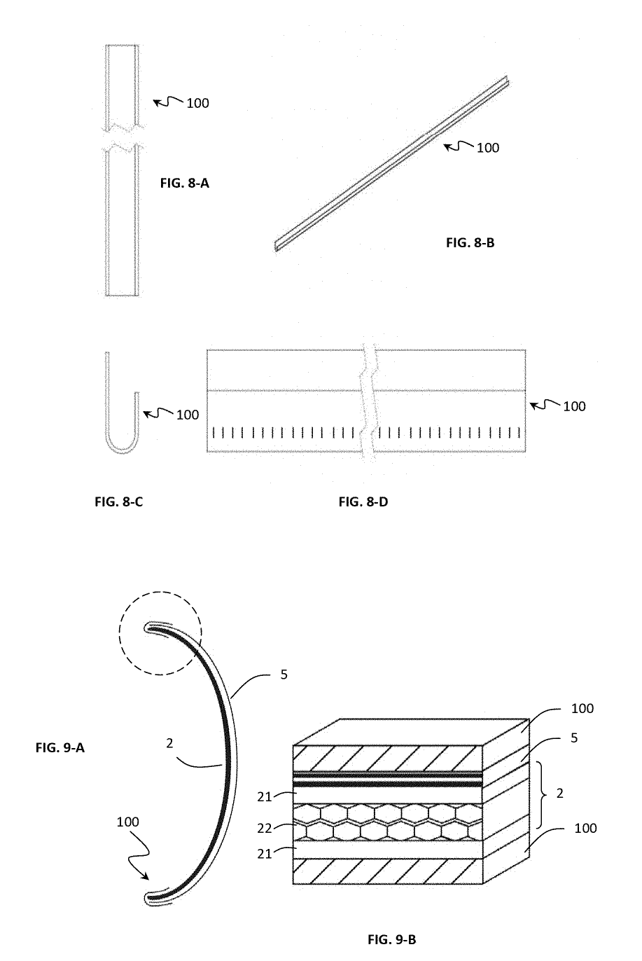

Referring to FIG. 4-J, there is shown the side view of another embodiment of the holder (100) wherein the first and second surfaces (121, 122) provide compression or clamping force, also capable of returning to original position after being tensioned or stretch opened to position (121T, 122T). Referring to FIGS. 5-A to 5-D show a curved holder top view, perspective view, side view, and front view, respectively. FIGS. 6-A to 6-D show a squared holder top view, perspective view, side view, and front view, respectively. FIGS. 7-A to 7-D show a partially curved holder top view, perspective view, side view, and front view, respectively. FIGS. 8-A to 8-D show a partially squared holder top view, perspective view, side view, and front view, respectively.

Referring to FIG. 9-A, there is shown a preferred method of the present invention of overlaying the display material (5) on the bin surface (2) preferably covering at least one bin edge or at least one bin corner, then securing both display material (5) and bin surface (2) with a holder (100) therein. FIG. 9-B shows an enlarged view of FIG. 9-A in a dashed circle.

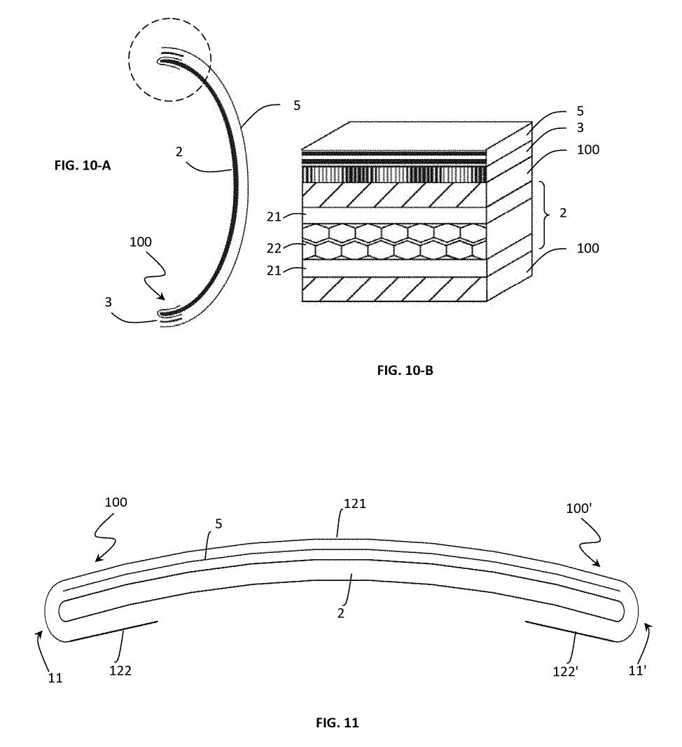

In FIG. 10-A, there is shown the present invention method of overlaying the display material (5) on top of the holder (100) comprising a layer of adhesive (3), detachable fastener, hook and loop fastener, such as but not limiting to velcro. The holder (100) can be placed on the bin side edges or bin corners. FIG. 10-B shows an enlarged view of FIG. 10-A in a dashed circle. It is contemplated that the display material (5) can be configured or adapted to comprising adhesive (3) or detachable fastener, such as but not limiting to velcro.

Referring to FIG. 11, there is shown another embodiment of the holder (100) wherein the spine (11) encapsulates the bin edge, the first surface (121) extends from the holder (100) therefrom to an opposite holder (100′) wherein its opposite spine (11′) encapsulates an opposite bin edge. While the second surface (122) extends from the spine (11) and an opposite second surface (122′) extends from the opposite spine (11′). It is understood or interpreted that either the first surface (121) or second surface (122) is on the stowage bin surface side which can be seen by passengers when the stowage bin is closed. Then, the display material (5) can be inserted between the first surface or second surface and the bin (2). For the display material (5) to be seen by the passengers, the first surface (121) or second surface (122) are made of transparent material. However, in an event the first surface (121) or the second surface (122) may serve as an additional protective layer of the bin surface, the display material (5) can be attached on the surfaces (121, 122). Hence, the surfaces (121, 122) are made of opaque or translucent material.

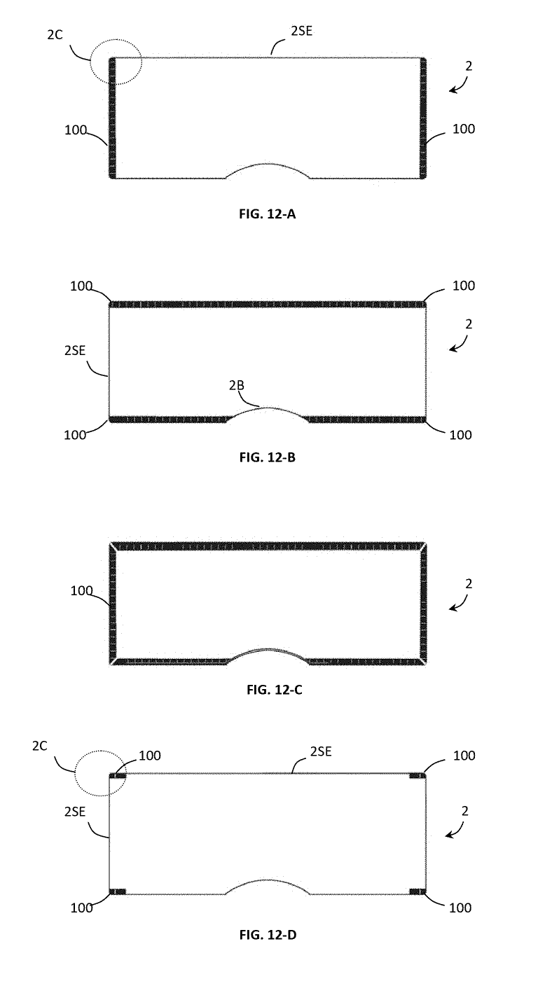

Referring to FIGS. 12-A to 12-D, there are shown a variety of the holder (100) affixing locations, preferably located on at least one bin corner (2C), or at least one bin side edge (25E), or a combination thereof. The bin bend edge (2B) is normally a region where a bin door latch is located, thus, the holder (100) is least preferred to be placed.

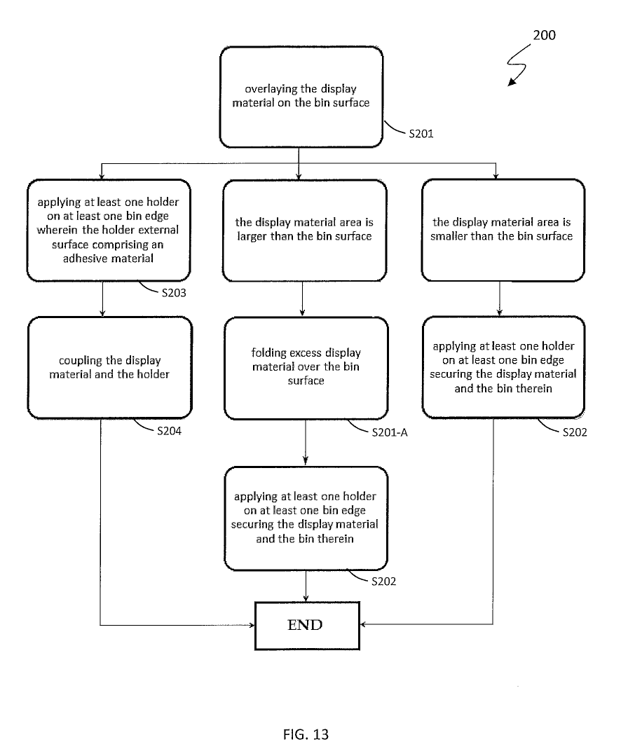

Referring to FIG. 13, there is shown an exemplary process flow of the present invention. A method of affixing display material on aircraft overhead stowage bin (200), comprising: overlaying the display material on the bin surface in step (S201).

It is understood that in an event whereby the display material (5) has a larger area than the bin surface, thus after the step (S201), folding excess display material over the bin surface (S201-A).

In an event whereby the display material (5) has equal or smaller area than the bin surface. Thereby applying at least one holder on at least one bin edge securing the display material and the bin therein in step (S202).

It is also contemplated that after the step (S201), applying at least one holder on at least one bin edge wherein the holder external surface comprising an adhesive material (S203). After the step (S203), coupling the display material and the holder (S204) together.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

What is claimed is:

1. A display material holder (100), comprising:
a spine (11) comprising a first longitudinal edge (121L) and second longitudinal edge (122L);
the first longitudinal edge (121L) wherein a first surface (121) extended therefrom; and
the second longitudinal edge (122L) wherein a second surface (122) extended therefrom;
characterized in that
the spine (11) inner surface is configured to encapsulate a bin (2) edge;
the first surface (121) and second surface (122) inner surface is configured to encapsulate the bin outer surface and a display material (5); and
the spine inner surface, first surface or second surface inner surface comprising an adhesion surface (15).

2. The display material holder (100) according to claim 1 wherein the adhesion surface (15) has a homogeneous or non-homogeneous material as the holder.

3. The display material holder (100) according to claim 2 wherein the adhesion surface (15) comprising dents, ribs, hooks, lumps, apertures, indentations, or combination thereof.

4. The display material holder (100) according to claim 1 is made of transparent, opaque, or translucent material.

5. The display material holder (100) according to claim 1 is made of rigid or flexible thermoplastic or its variants, metal, fiberglass, kevlar, composite materials, or a combination thereof.

6. The display material holder (100) according to claim 1 is made of rubber or any rubber variants.

7. The display material holder (100) according to claims 5 and 6 wherein the thermoplastic or its variants, rubber or its variants, metal, fiberglass, kevlar, composite materials, or a combination thereof, is fire retardant material comply with interior aircraft part airworthiness safety regulations.

8. The display material holder (100) according to claim 1 wherein the display material (5) comprising adhesive material or detachable fastener.

9. The display material holder (100) according to claim 1 wherein the display material (5) is made of, but not limiting to, polyethylene terephthalate, low density polyethylene, high density polyethylene, polyester, vinyl, polycarbonate, polystyrene, polyvinylchloride, polypropylene, or a combination thereof, or other thermoplastic variants thereof.

10. The display material holder (100) according to claim 1 wherein the first surface (121) and second surface (122) are capable of return to original position after being tensioned or stretched.

11. The display material holder (100) according to claim 10 wherein first surface (121) and second surface (122) are made of transparent, opaque, or translucent material.

12. The display material holder (100) according to claims 10 and 11 wherein the first surface (121) or second surface (122) of the holder (100) joins with an opposite holder (100′) comprising an opposite spine (11′) and an opposite second surface (122′) extends therefrom.

13. A method affixing display material on aircraft overhead stowage bin (200), comprising:
overlaying the display material on the bin surface (S201);
characterized in that
applying at least one holder on at least one bin side edges, or bin corners, or a combination thereof; securing the display material and the bin therein (S202).

14. The method (200) according to claim 13 wherein after the step (S201), folding excess display material over the bin surface (S201-A).

15. The method (200) according to claim 13 wherein after the step (S201), applying at least one holder on at least one bin edge wherein the holder external surface comprising an adhesive material (S203).

16. The method (200) according to claim 14 wherein after the step (S203), coupling the display material and the holder (S204).
